(19) United States
(12) Patent Application Publication
(10) Pub. No.: US 2002/0143889 A1
(43) Pub. Date: Oct. 3, 2002

(54) Utilization of equipment displays for communication of information unrelated to operation of the equipment

(76) Inventor: Samuel M. Lester, Boise, ID (US)

Correspondence Address: HEWLETT-PACKARD COMPANY, Intellectual Property Administration, P.O. Box 272400, Fort Collins, CO, 80527-2400, US

(21) Appl. No.: 09/767,605

(22) Filed: Jan. 22, 2001

(51) Int. Cl. G06F 15/16

(52) U.S. Cl. 709/217

(57) ABSTRACT

Office equipment are used to display information, such as news items, stock quotes, event announcements, and so on, on a display ordinarily used by the office equipment to provide status as to operation of the office equipment. A computing system is in communication with the office equipment. The computing system obtains information unrelated to operation of the office equipment and causes the office equipment to display the information in place of a status message.

### BACKGROUND

The present invention concerns computer networking and pertains particularly to utilization of equipment displays for communication of information unrelated to operation of the equipment.

As the availability of information increases, it is desirable to allow a user to conveniently and specifically access the information that is most pertinent and interesting to the user. The internet and other networking systems allow a user to access information and communicate accessed information to others. For example, the product EntryPoint is an Internet toolbar and personalized alerting service that delivers customized content directly to a Window on the user's desktop. The customized content can include alerts, news, stock activity, sports scores, and so on. See the web site at www.entrypoint.com, created by Entrypoint, Incorporated, having a business address of 10421 Wateridge Circle, Suite 200, San Diego, Calif. 92121.

The product Instant Delivery allows a user to select news and information that interests a user. The selected information is printed out on a user's printer. See the web site at www.instant-delivery.com, created by Hewlett-Packard Company, having a business address of 3000 Hanover Street, Palo Alto, Calif. 94304.

However, it is desirable to increase the convenience by which a user can access specific information in which the user is interested.

### SUMMARY OF THE INVENTION

In accordance with the preferred embodiments of the present invention, office equipment are used to display information, such as stock quotes, event announcements, and so on, on a display ordinarily used by the office equipment to provide status as to operation of the office equipment. A computing system is in communication with the office equipment. The computing system obtains information unrelated to operation of the office equipment and causes the office equipment to display the information in place of a status message.

For example, the office equipment is a printer, a scanner, a fax machine, a telephone, a telephone answering machine or any other type of office equipment that includes an information display.

The computing system obtains the information, for example, from an internet site, a site on another network, or from another computing system which requests display of the information. The computing system generates instructions to the office equipment to display the information. The computing system sends the instructions to the office equipment. When the office equipment executes the instructions, this results in the office equipment displaying the information on a display used by the office equipment to provide status as to operation of the office equipment. The information is displayed in place of a status message.

The present invention increase the flexibility and the outlets through which news items, company announcements, advertisements and so on can be communicated. This increases the flexibility and convenience of data communication.

### BRIEF DESCRIPTION OF THE DRAWINGS

FIG. 1 illustrates obtaining information for display on equipment in accordance with a preferred embodiment of the present invention.

FIG. 2 shows equipment display being used to display a news item in accordance with a preferred embodiment of the present invention.

### DESCRIPTION OF THE PREFERRED EMBODIMENT

In accordance with the preferred embodiments of the present invention, common office equipment are used to display important information, such as stock quotes, event announcements, and so on. The minimum requirements are that office equipment has a display of some sort and that the display is programmable, preferably remotely programmable.

In the preferred embodiment, this is implemented using one or more computing devices to gather information and one or more pieces of office equipment to display the information. Additionally, there can be one or more additional computing devices separate from the computing devices used to gather information. These one or more additional computing devices are used, for example, to control the display of information on the office equipment. Alternatively, the same computing devices used to gather information can control the display of information on the office equipment.

The computing devices used to gather information get the information to be displayed from, for example, the internet, other databases, or other providers of information. The computing devices used to gather information then put in a broadcast request for the appropriate time and locations. The computing systems that control display of the information translate the broadcast request into the proper display protocol for each office equipment on which the information is to be displayed.

For example, the computing systems that control display of information can check to determine which of the available office equipment fit any time/location criteria or other display criteria pertaining to the display of the information. To that end the computing systems that control display of the information stores pertinent information about each item of the office equipment in a knowledge base.

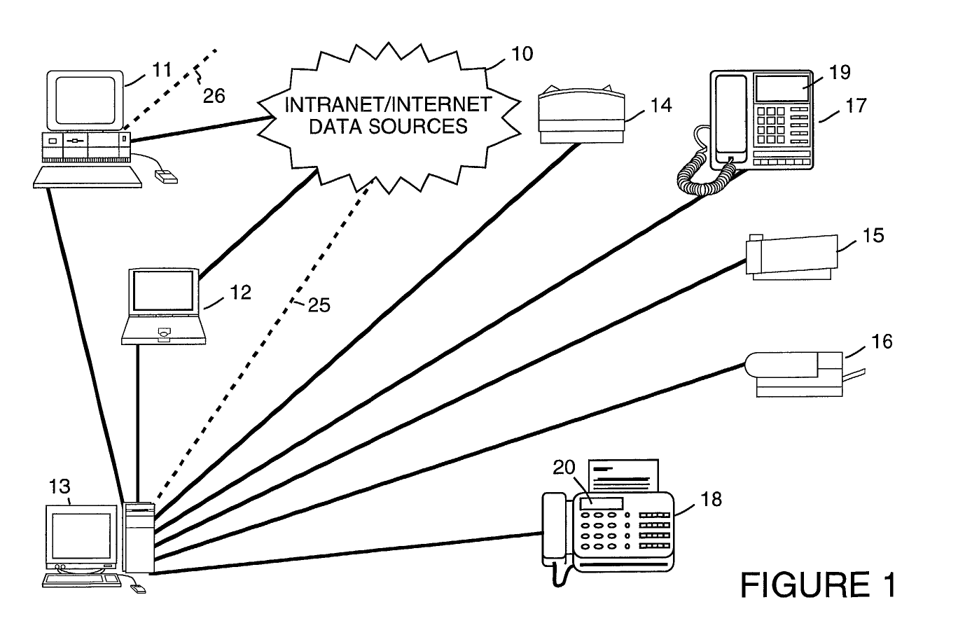

FIG. 1 illustrates operation of the present invention. A computing device 11 and a computing device 12 are used to gather information from intranet/internet data sources 10. Alternatively, information may be gathered by other means. For example, information may be gathered directly from a different entity by using modem-to-modem contact, or by using wireless communication. The information also may be placed into a computer device directly by a user.

Through a local area network (LAN) and/or a wide area network, computing device 11 and/or computing device 12 send broadcast requests to a computing system 13. Computing system 13 is connected to one or more pieces of office equipment, represented in FIG. 1 by a printer 14, a telephone 17, a printer 15, a printer 16 and a fax machine 18. Printer 14, printer 15, printer 16, telephone 17 and fax machine 18 are representative of various kinds of office equipment. Additional types of office equipment may also be used to show data. For example, an answering machine, a scanner, and/or any other type of office equipment with a display can be used to display information. Connection can be made by physical wire connections. Alternatively connection can be made using wireless services such as cell phones, pagers, optical transmission, and so on.

Telephone 17 includes a display 19. Fax machine 18 includes a display 20. Printer 14, printer 15 and printer 16 also each include a display.

When computing system 13 receives a broadcast request from computing system 11 and/or computing system 12, computing system 13 translates the broadcast request into the proper display protocol for each office equipment on which the information is to be displayed.

For example, the information to be displayed is a stock quote that is periodically updated. Computing system 12 obtains the stock quote periodically from the internet. For example, computing system obtains a stock quote for Hewlett-Packard Company (HWP) on Sep. 4, 2000 at 10 AM, and forwards the stock quote to computing system 13.

Computing system 13 translates the broadcast request into the proper display protocol for each office equipment on which the information is to be displayed. For example, printer 14 is an HP LJ 4000 printer available from Hewlett-Packard Company. Computing system 13 generates the following commands to have the stock quote displayed on printer 14, as set out in Table 1 below:

TABLE 1

ˆ [%-12345X
@PJL RDYMSG DISPLAY = “HWP 123.8 9/4 10:00AM”
@PJL COMMENT “HP NETWORK NEWS DISPLAY JOB”
@PJL RESET
ˆ [%-12345X

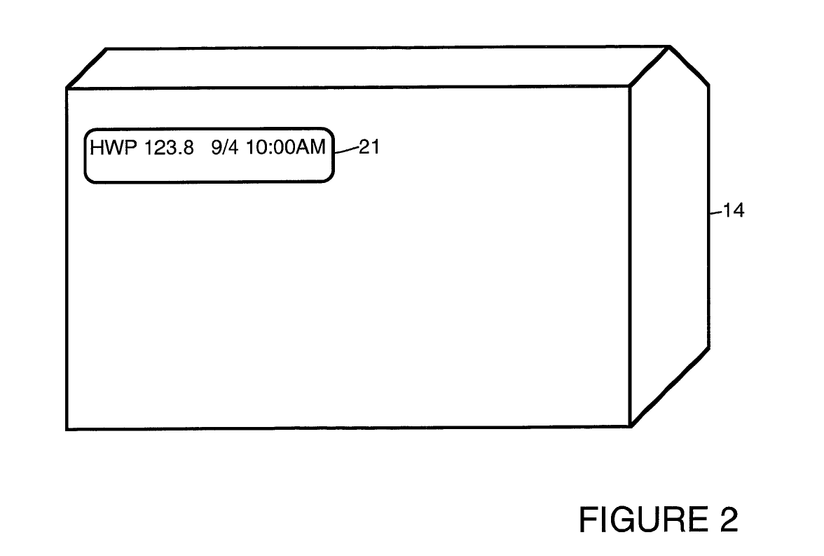

Computing system 13 forwards the commands to printer 14. As illustrated by FIG. 2, printer 14 displays the stock quote on a display 21.

Similarly, computing system 13 sends command sequences to other pieces of office equipment selected to display the stock quote.

FIG. 1 is only illustrative of one arrangement of devices. For example, as illustrated by a datapath 25, computing system 13 can be directly connected to intranet/internet data sources 10, and thus obtain information without the use of computing system 11 or computing system 12. Likewise, as illustrated by a datapath 26, computing system 11 can be connected to other computing systems which can be used to display information on additional pieces of office equipment.

The foregoing discussion discloses and describes merely exemplary methods and embodiments of the present invention. As will be understood by those familiar with the art, the invention may be embodied in other specific forms without departing from the spirit or essential characteristics thereof. Accordingly, the disclosure of the present invention is intended to be illustrative, but not limiting, of the scope of the invention, which is set forth in the following claims.

I claim:

1. A system comprising:
office equipment that includes a display, a display being used by the office equipment to provide status as to operation of the office equipment;
a computing system, in communication with the office equipment, the computing system for obtaining information unrelated to operation of the office equipment, and for causing the office equipment to display the information in place of a status message.

2. A system as in claim 1 wherein the office equipment is at least one of the following:
a printer;
a scanner;
a fax machine;
a telephone; and,
a telephone answering machine.

3. A system as in claim 1 wherein the computing system obtains information from a site on a network.

4. A system as in claim 1 wherein the computing system obtains information from an internet site.

5. A system as in claim 1 wherein the computing system obtains information from another computing system which requests display of the information.

6. A method comprising:
(a) obtaining, by a computing system, information unrelated to operation of office equipment;
(b) generating, by the computing system, instructions to the office equipment to display the information;
(c) sending the instructions from the computing system to the office equipment; and,
(d) displaying the information by the office equipment that on a display used by the office equipment to provide status as to operation of the office equipment, the information being displayed in place of a status message.

7. A method as in claim 6 wherein in step (a) the office equipment is at least one of the following:
a printer;
a scanner;
a fax machine;
a telephone; and,
a telephone answering machine.

8. A method as in claim 6 wherein in step (a) the computing system obtains information from a site on a network.

9. A method as in claim 6 wherein in step (a) the computing system obtains information from an internet site.

10. A method as in claim 6 wherein in step (a) the computing system obtains information from another computing system which requests display of the information.

11. A computing system comprising:
first communication means for obtaining information unrelated to operation of office equipment;
processing means for translating the information into instructions to the office equipment to display the information on a display used by the office equipment to provide status as to operation of the office equipment, wherein the instructions instruct the office equipment to display the information in place of a status message; and,
second communication means for sending the instructions from the computing system to the office equipment.

12. A computing system as in claim 11 wherein the office equipment is at least one of the following:
a printer;
a scanner;
a fax machine;
a telephone; and,
a telephone answering machine.

13. A computing system as in claim 1 1 wherein the first connection means provides connection of the computing system to a site on a network.

14. A computing system as in claim 11 wherein the first connection means provides connection of the computing system to an internet site.

15. A computing system as in claim 11 wherein the first connection means provides connection of the computing system to another computing system which requests display of the information.
